(19) United States
(12) Patent Application Publication
(10) Pub. No.: US 2015/0046330 A1
(43) Pub. Date: Feb. 12, 2015

(54) TRANSACTION PROCESSING SYSTEM AND METHOD

(71) Applicant: Global Blue Holdings AB, Singapore (SG)

(72) Inventors: Waleed Hanafi, Singapore (SG); Stefano Bassi, Gallarate (IT)

(73) Assignee: GLOBAL BLUE SA, Eysins (CH)

(21) Appl. No.: 14/379,416

(22) PCT Filed: Feb. 20, 2013
(86) PCT No.: PCT/EP2013/053328

§ 371 Date: Aug. 18, 2014

(30) Foreign Application Priority Data
Feb. 21, 2012 (SG) 201201227-4

(51) Int. Cl. G06Q 20/40; G06Q 20/32

(52) U.S. Cl. CPC G06Q 20/401; G06Q 20/322; G06Q 20/3278
USPC 705/44

(57) ABSTRACT

A secure storage system securely stores customer information including, for a customer, payment account information, mobile communications device access information and customer verification information associated with mobile communications device identification information. Transactions can be conducted at a merchant system without the merchant system being provided with customer payment account details on presentation of the mobile communications device, payment being effected though the use of the secure storage system interacting with a merchant terminal device and an application on the mobile communications device.

### BACKGROUND

The present invention relates to a transaction processing system and method. In particular the present invention relates to a system and method that enables transactions between a customer (user) and a merchant in a secure and reliable method without the user having to present a payment card, a cheque or cash to a merchant.

There is a need to provide secure methods of conducting cash-free transactions between customers and merchants. Currently, the typical method of conducting cash free transactions between customers and merchants is through the use of payment cards such as credit, debit, pre-payment cards or the like. Such cards have taken over from cheques as the usual method of conducting such transactions. However, despite advancements in security of the use of payment cards, for example through the use of chip and PIN cards, fraudulent use of such cards is still a significant issue.

US 2011/0276478 describes a system that associates payments with telephone numbers. A data storage facility and an interchange coupled with the data storage facility store purchase receipts in association with phone numbers. The interchange includes a common format processor and a plurality of converters to interface with a plurality of different controllers of mobile communications. The converters are configured to communicate with the controllers in different formats and with the common format processor in a common format, to obtain a confirmation of a payment request that identifies a phone number, a merchant and a purchase from the merchant. After a confirmation is received, the interchange uses funds associated with the phone number to pay the merchant for the purchase and to receive and store a receipt for the purchase from the merchant.

US2009/0307139 describes a method for authenticating a financial transaction at a point of sale using an application program in a first secure element of a mobile phone that is configured to generate instruction codes to effect the financial transaction upon verification of a user's identity. The user's credentials are stored in a second secure element of the phone, which is operable to verify the user's identity from a biometric trait of the user input to the phone and to generate data authenticating the financial transaction in response to the verification of the user's identity. At a point of sale, the user invokes the application and then inputs a biometric trait to the phone. The second secure element verifies the user's identity, and upon verification, generates data authenticating the transaction. The financial transaction data, including the instruction codes and the authenticating data, are then transmitted from the phone to the point of sale.

WO 2011/112752 describes techniques for facilitating electronic commerce and financial transactions conducted via one or more mobile devices and for facilitating identity verification and authentication transactions to be performed via communications with a user's mobile device.

Although various approaches have been suggested, there remains a need for a more secure way of enabling transactions between customers and merchants.

The present invention seeks to provide a technological solution to such problems.

### SUMMARY

Aspects of the invention are defined in the claims.

In an embodiment, a storage system can comprise storage securely storing user (customer) information including, for a user, mobile communications device information, including mobile communications device identification information that identifies an instance of a mobile communications device application on a mobile communications device, and payment account information and user verification information associated with the mobile communications device identification information. Storage system processing means can be configured: to receive from a transaction system a first transaction authorisation request message including transaction amount information, mobile communications device identification information and user verification information; to determine whether the received user verification information corresponds to stored user verification information for the mobile communications device identified in the transaction authorisation request and, where the received user verification information corresponds to the stored user verification information; to retrieve from the storage the payment account information associated with the mobile communications device identification information; to transmit to an authorisation system a second authorisation request message that includes the transaction amount information and the payment account information; and on receipt from the authorisation system of a first authorisation response message in response to the second authorisation message to cause a second authorisation response message to be transmitted to the transaction system without identifying the payment account information.

In an embodiment, a transaction system can comprise transaction system processing means configured on receipt from a merchant system of an initial transaction authorisation request message including transaction amount information and mobile communications device identification information, to obtain mobile communications device access information associated with the mobile communications device identification information, to transmit to the mobile communications device a transaction verification request message including transaction amount information and a request for user verification information, and in response to receipt, from the mobile communications device of a transaction verification response message user verification information, to transmit to the storage system the first transaction authorisation request message including the transaction amount information, the mobile communications device identification information and the user verification information.

In an embodiment, a merchant system can comprise means for inputting product identification information for a purchase transaction, means for inputting mobile device identification information identifying a user's mobile communications device for the purchase transaction, merchant system processing means operable to transmit, to the transaction system, the initial transaction authorisation request message including the transaction amount information and mobile communications device identification information, and on receipt, from the transaction system, of the second authorisation response message to issue a receipt for completing the purchase transaction for the user.

In an embodiment, a registration server can be configured to communicate with an application on a mobile communications device to identify an identifier for the mobile communications device hardware and an instance of the application, to generate a unique mobile communications device identifier for the instance of the application on that mobile communications device from the identifiers for the instance of the application and for the mobile communications device hardware, and to transmit the unique mobile communications device identifier for storage by the application on the mobile communications device.

A method of operation can comprise: securely storing, on a storage of a storage system, user information including, for a user, storage securely storing user information including, for a user, mobile communications device information, including mobile communications device identification information that identifies an instance of a mobile communications device application on a mobile communications device, and payment account information and user verification information associated with the mobile communications device identification information; receiving at the storage system from a transaction system a first transaction authorisation request message including transaction amount information, mobile communications device identification information and user verification information; determining by the storage system whether the received user verification information corresponds to stored user verification information for the mobile communications device identified in the transaction authorisation request and, where the received user verification information corresponds to the stored user verification information, retrieving by the storage system from the storage payment account information associated with the mobile communications device identification information and transmitting by the storage system to an authorisation system a second authorisation request message that includes the transaction amount information and the payment account information, and on receipt by the storage system from the authorisation system of a first authorisation response message in response to the second authorisation message, causing a second authorisation response message to be transmitted to the transaction system without identifying the payment account information.

A method of operation can comprise steps performed by a registration server of communicating with an application on a mobile communications device to identify an identifier for the mobile communications device hardware and an instance of the application on the mobile communications device, generating a unique mobile communications device identifier for the instance of the application on that mobile communications device from the identifiers for the instance of the application and for the mobile communications device hardware and transmitting the unique mobile communications device identifier for storage by the application on the mobile communications device.

An embodiment enables transactions to be conducted at a merchant system without the merchant system being provided with user payment account details, payment being effected though the interaction of a secure storage system, a merchant terminal device and an application on a mobile communications device.

### BRIEF DESCRIPTION OF THE DRAWINGS

Embodiments are described, by way of example only, with reference to the accompany drawings.

FIG. 1 is a schematic diagram giving an overview of a embodiment of transactions system;

FIG. 2A is a schematic representation of an example merchant terminal device (MTD) and FIG. 2B is a schematic block diagram of functional components of the example MTD;

FIG. 3A is a schematic representation of an example mobile communications device (MCD) and FIG. 2B is a schematic block diagram of functional components of the example MCD;

FIG. 4 is a schematic representations of a merchant system;

FIG. 5 is a schematic representation of an example host system;

FIG. 6 is a schematic representation of an example storage system;

FIG. 7 is a flow diagram illustrating part of a transaction flow;

FIG. 8 is a diagram illustrating an initialisation process;

FIG. 9 is an alternative representation of a process flow.

### DETAILED DESCRIPTION

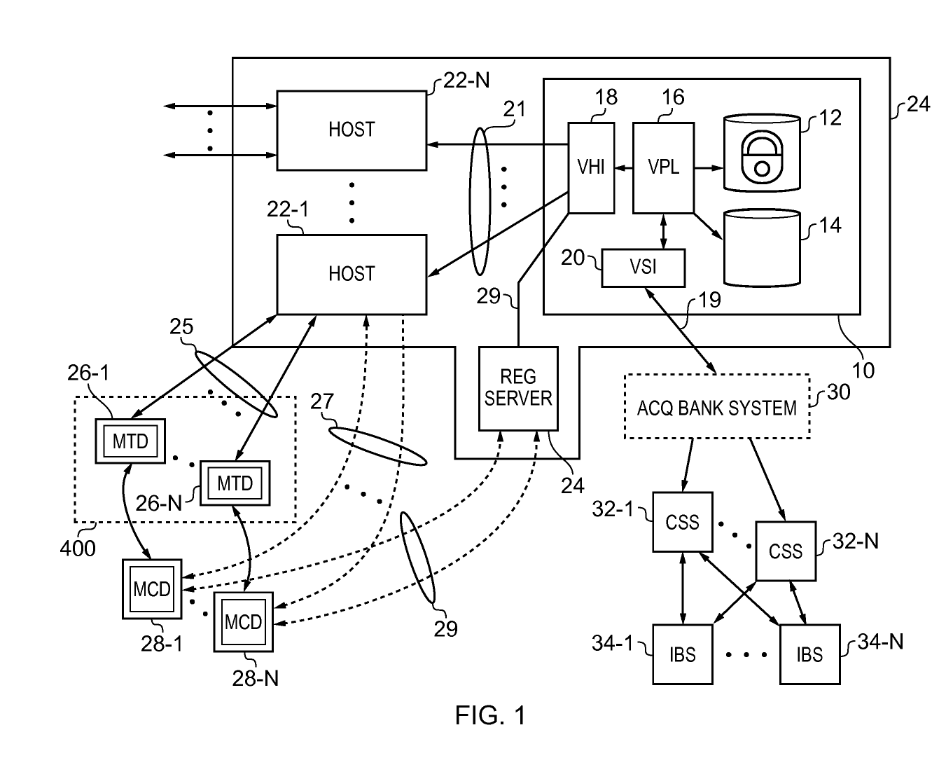

FIG. 1 provides an overview of an example configuration of a system embodying the present invention. An example embodiment can provide simplicity and flexibility of use as perceived by both customers (users) and merchants, while also providing security and integrity of operation. An example embodiment enables communication between a mobile communications device of a customer and a merchant system to support transactions between the customer and the merchant without a customer needing to present a payment card to a merchant.

FIG. 1 is a schematic diagram providing an overview of an example configuration of a system for implementing an embodiment of the present invention. A payment services system 24 in the present example comprises a plurality of host systems (also referred to herein as transaction systems) 22, here represented as hosts 22-1 to 22-N and one or more vault systems (also referred to herein as storage systems) 10, here represented by a single vault system 10.

In the example shown, the vault system 10 comprises one or more vault processors 16 executing vault processing logic (VPL) and secure vault storage 12 that contains encrypted information. Further storage 14 comprises software and data defining the VPL and used for controlling the operation of the vault processor(s) 16. The vault processor(s) 16 is/are operable to communicate with the host systems 22-1-22-N over secure channels 21 via a vault-host interface (VHI) 18. The secure channels 21 can be implemented as point-to-point channels, either via direct point-to-point communication links, or via point-to-point links established over a network using conventional point-to-point communication techniques.

In the illustrated example, a vault system interface (VSI) 20 provides a secure communication channel between the vault processor(s) 16 of the vault system 10 and external systems such as an acquiring bank system 30, which in turn is connected by further links to card scheme systems 32-1-32-N, or alternatively directly with the card scheme systems 32-1-32-N. The card scheme systems 32-1-32-N are in turn connected via further secure links to systems of issuing banks 34-1-34-N responsible for issuing individual cards under the card schemes. In another example, the VSI 20 could connect directly to bank systems 34-1-34-N for bank to bank transfers, for example for payments not using card payment schemes.

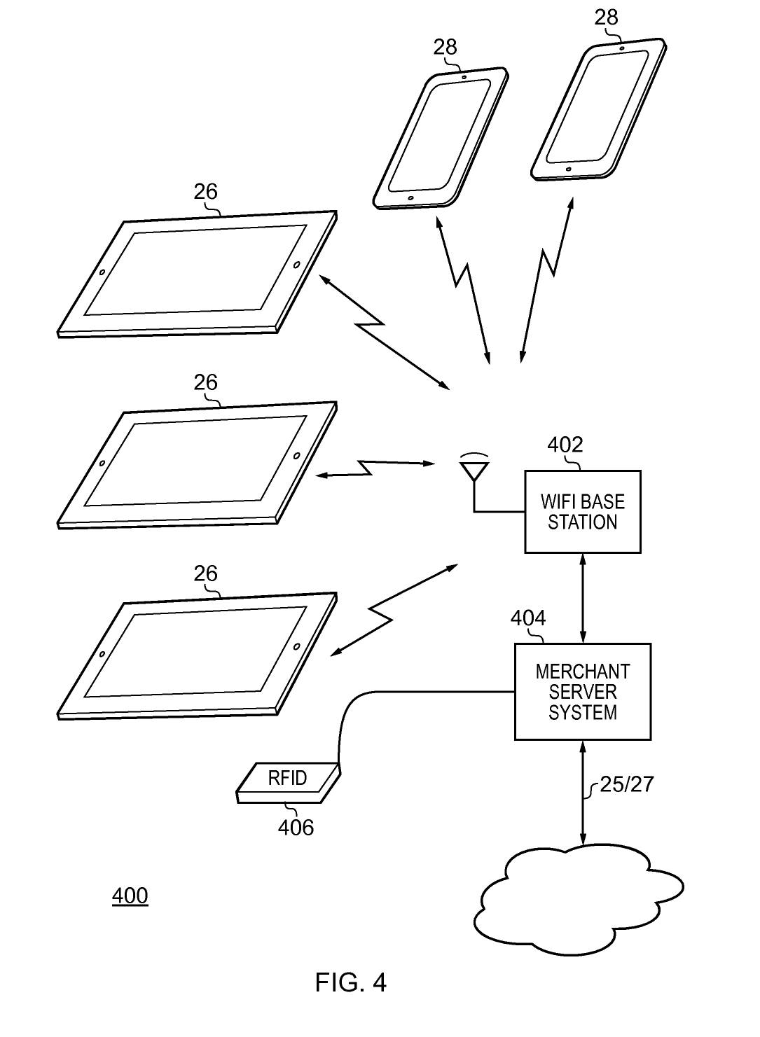

In the example embodiment, a host system 22 is operable to connect with the merchant terminal devices 26 of one or more merchant system(s) 400. FIG. 1 illustrates the host system 22-1 directly connected via secure links 25 with individual merchant terminal devices (MTDs) 26-1-26-N. In the example embodiment represented in FIG. 1, the host system 22-1 effectively acts as a virtual point of sale (VPOS), with the merchant terminal devices 26-1-26-N acting as input devices held by individual merchant employees for the capture and presentation of information. The merchant terminal devices 26-1-26-N could, for example, be formed by a tablet style computing device. The connections to the merchant terminal devices could be established as direct point-to-point connections, for example via a secure channel over a network (for example the Internet or a network local to the merchant). Alternatively, the connections could be established via a merchant terminal system as described later with reference to FIG. 4, the merchant terminal system being connected to the host system 22-1 via a secure channel. It should be noted that, in alternative embodiments, the host system 22-1 could communicate via such a secure channel with a merchant system that includes a merchant server system and one or more conventional point of sale devices (cash registers), for example, connected by a merchant server system to the host 22-1.

FIG. 1 also illustrates a registration server 24 that can be operable to communicate with the mobile communications devices 28 via secure channel(s) 29 (for example via a mobile telephony network or via, for example, the Internet, or a combination of both).

In an example embodiment of the invention, a transaction can be performed between a customer and a merchant through the use of a mobile communications device (MCD) 28, such as a smart phone. As will be explained in the following description, an information exchange can take place between a mobile communications device 28 of a customer and a merchant terminal device 26 of a merchant, optionally with out of band communication channels 27 between the host 22-1 and the mobile communications device 28.

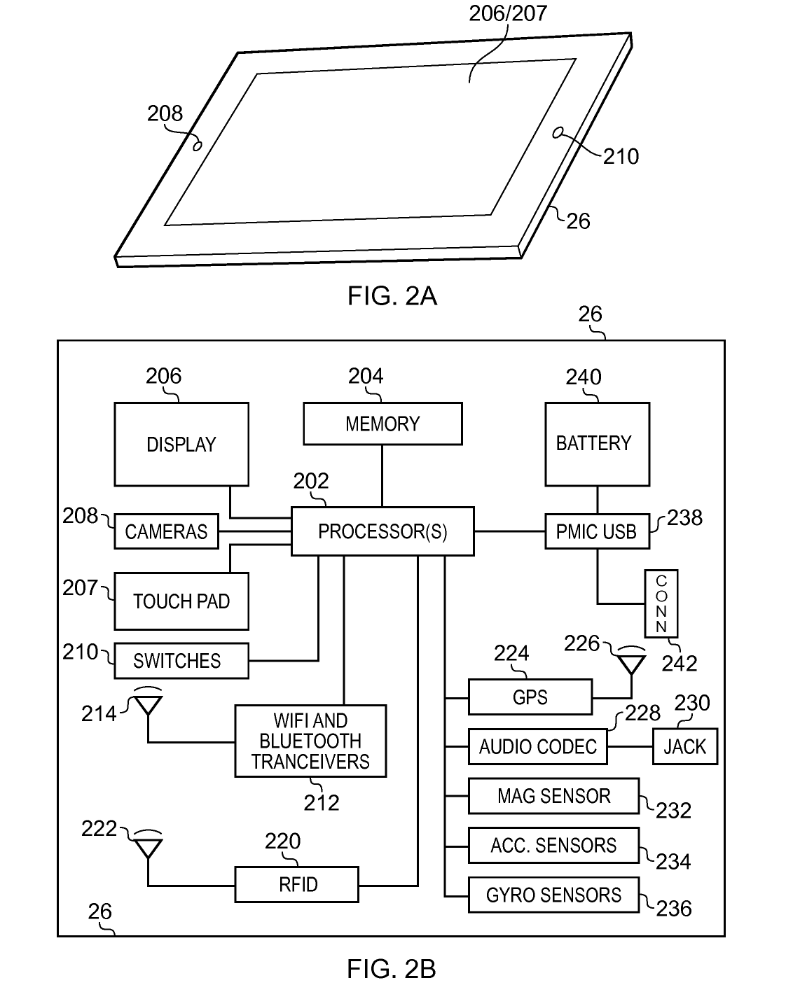

FIG. 2A is a schematic representation of a merchant terminal device (MTD) 26 in the form of a tablet. The tablet 26 includes a display 206 with a touch pad 207, one or more cameras 208 (for example, a camera may be provided on the front and/or back and/or sides of the tablet) and one or more switches 210 (for example, one or more switches may be provided on the front and/or back and/or sides of the tablet 26).

FIG. 2B is a schematic representation of functional elements provided in such a tablet 26. The tablet 26 includes one or more processors 202 and one or more memory devices 204 that can include volatile memory (e.g., RAM) and non-volatile memory (e.g., flash memory, ROM, etc).

The memory 204 contains programs and data for controlling the processor(s) 202 of the tablet 26. The tablet 26 includes the display 206 and a touch pad 207 for merchant input and selection of information displayed on the display 206 in a manner that is well understood to the person skilled in the art.

The one or more cameras 208 can be used to capture visually presented information (for example, barcodes, QR codes, etc). The one or more switches 210 can be used to control hard functions such as switching on or off of the tablet, selecting between modes of use, opening and/or closing applications, etc.

WiFi and/or Bluetooth transceivers 212 connected to one or more aerials 214 can be used to enable wireless communication between the tablet and a base station and also between the tablet and other devices (e.g., the mobile communications device 28 of a customer). Optionally, the tablet can also be provided with an integrated radio frequency identification (RFID) interface 220 which is connected to an RFID aerial 222. The RFID interface 220 can be used to present an RFID code to another device and/or can be configured to read RFID codes provided on other devices and/or products to be read.

The tablet 26 can also include other sensors and interfaces, including, for example, Global Positioning Satellite Logic (GPS Logic) 224 connected to a GPS aerial 226. An audio codec 228 can be connected to an audio jack 230 for connection to an external speaker, if required. Various other sensors can be used to enable the tablet to be sensitive to position and/or movement, including, for example, a magnetic sensor 232, accelerometers (acceleration sensors) 234 and gyroscopic (gyro) sensors 236. The tablet 26 can be powered either from an internal battery 240 or from an external power provided by a connector 242, the battery 240 and the connector 242 being connected to a power management integrated circuit (PMIC)/universal serial bus (USB) interface 238.

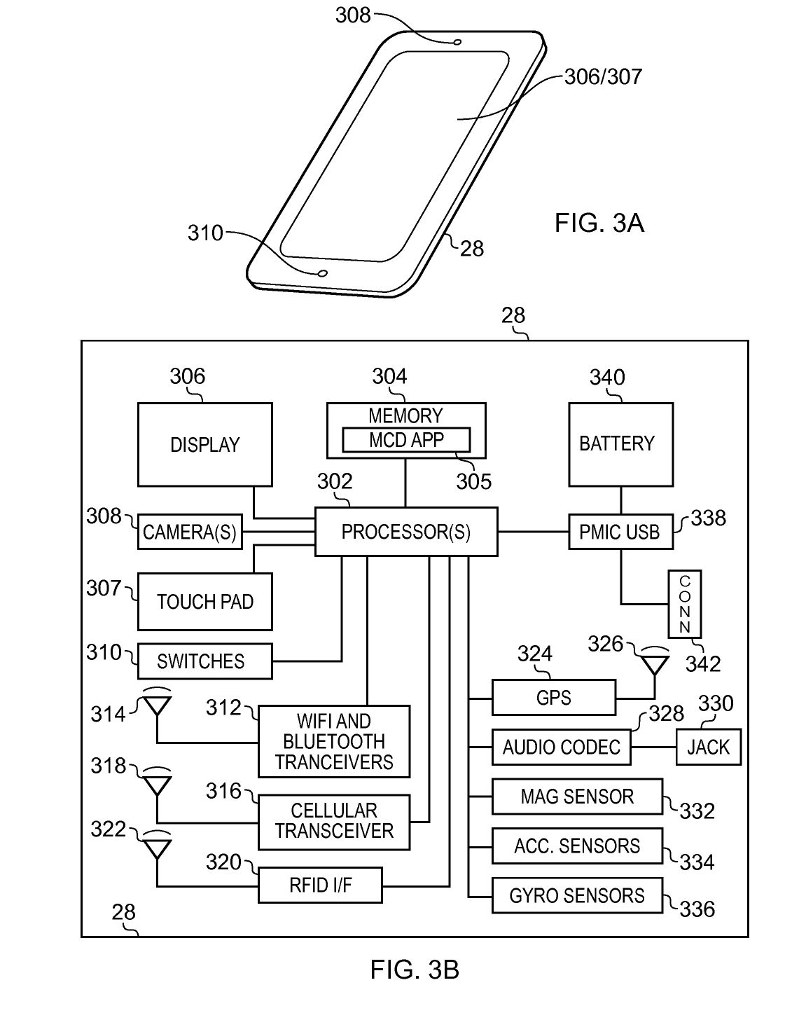

FIG. 3A is a schematic representation of a mobile communications device (MCD) 28. The mobile communications device 28 includes a display 306 with a touch pad 307, one or more cameras 308 (for example, a camera may be provided on the front and the back of the mobile communications device) and one or more switches 310 (for example, one or more switches may be provided on the front/back and/or sides of the mobile communications device 28).

FIG. 3B is a schematic representation of functional elements provided in such a mobile communications device 28. The mobile communications device 28 includes one or more processors 302 and one or more memory devices 304 that can include volatile memory (e.g., RAM) and non-volatile memory (e.g., flash memory, ROM, etc).

The memory 304 contains programs and data for controlling the processor(s) 302 of the mobile communications device 28. In particular, the mobile communications device can include a transaction application (hereinafter referred to as a mobile communications device application (MCDAPP) 305) for conducting transactions using the mobile communications device. The mobile communications device 28 includes the display 306 and a touch pad 307 for customer input and selection of information displayed on the display 306 in a manner that is well understood to the person skilled in the art. The display can also be used for displaying a visually readable code, for example a bar code or QR code representing a unique identifier for an instance of an application on the mobile communications device used for providing a unique mobile communications device identifier identifying the mobile communications device to a merchant terminal device, or the merchant terminal system as will be explained later.

The one or more cameras 308 can be used to capture visually presented information (for example, barcodes, QR codes, etc). The one or more switches 310 can be used to control hard functions such as switching on or off of the mobile communications device, selecting between modes of use, opening and/or closing applications, etc.

WiFi and/or Bluetooth transceivers 312 connected to one or more aerials 314 can be used to enable wireless communication between the mobile communications device and a base station and also between the mobile communications device and other devices (for example a merchant terminal device 26). Optionally, the mobile communications device can also be provided with an integrated radio frequency identification (RFID) interface 320 which is connected to a suitable RFID aerial 322. The RFID interface 320 can be used to present an RFID code to another device and/or can be configured to read RFID codes provided on other devices and/or products to be read.

A cellular transceiver 316 that is provided to one or more aerials 318 is provided to enable the mobile communications device to communicate via a mobile telecommunications network (e.g., a cellular wireless network).

The mobile communications device 28 can also include other sensors and interfaces, including, for example, Global Positioning Satellite Logic (GPS Logic) 324 connected to a GPS aerial 326. An audio codec 328 can be connected to an audio jack 330 for connection to an external speaker, if required. Various other sensors can be used to enable the mobile communications device to be sensitive to position and/or movement, including, for example, a magnetic sensor 332, accelerometers (acceleration sensors) 334 and gyroscopic (gyro) sensors 336. The mobile communications device 28 can be powered either from an internal battery 340 or from an external power provided by a connector 342, the battery 340 and the connector 342 being connected to a power management integrated circuit (PMIC)/universal serial bus (USB) interface 338.

FIG. 4 is a schematic representation of an example configuration at a merchant site. In this example, one or more merchant terminal devices 26 are able to communicate wirelessly, e.g., using a WiFi connection to a WiFi base station 402. The WiFi base station 402 is connected to a merchant server system 404 which in turn is connected via the secure communications channel to the host system 22 shown in FIG. 1. In this example, one or more a RFID reader(s) 406 can be provided and connected to the merchant server system 404, for example for use where the individual merchant terminal devices 26 are not provided with an RFID interface. As indicated in FIG. 4, it is envisaged that the mobile communications devices 28 of customers can also connect to the WiFi base station of the merchant system to enable the connection of the mobile communications devices to the host system 22 (for example, by establishing the secure channels 27 via the WiFi base station and the merchant server system to the host system 22.

The connection of the mobile communications device 28 of a customer to the merchant terminal system can be achieved in various ways. For example, the mobile communications device application 305 can be configured to use geolocation functionality of the mobile communications device (using one or more of the WiFi, GPS, cellular and accelerometer/gyro/magnetic functionalities of the mobile communications device) to recognise the current location of the mobile communications device and to use pre-stored information (for example an SSID and passphrase linked to a geographic location) to automatically connect to a WiFi base station 402 at a merchant premises and to then to establish a secure connection to the merchant system 404 and/or to a host system 22. Optionally, the customer can be prompted to accept the connection to the base station 402 by receiving a prompt on the display of the mobile communications device, with the connection only then being established in response to positive customer agreement to the connection. In addition to, or as an alternative to the automatic connection in response to pre-stored information, in one example the information for connection to a WiFi base station 402 in a merchant's premises can be achieved in response to the customer receiving the SSID and passphrase by reading an RFID tag or a displayed visual code (e.g., a bar code, or QR code) at the merchant premises, where the RFID tag or the displayed visual code provides the SSID and the passphrase for connection to the base station 402.

In one example, each merchant terminal device can be provided with such a visual code and/or an RFID tag to be read by a mobile communications device application using a camera 308 or RFID interface 320 of the customer's mobile communications device 28. The visual code and/or RFID tag of a merchant terminal device 26 can be configured not only to provide information for wireless connection of the consumer's mobile communications device to a network of the merchant, but also to enable the linking of the customer's mobile communications device 28 to the merchant terminal device 26 for enabling transactions between the customer's mobile communications device 28 and that merchant terminal device 26.

In a further example, communication between the customer's mobile communications device 28 and the host system 22 can be effected using an out of band channel 27, for example via a mobile telephony network. In such an example, a merchant terminal device can be provided with a visual code and/or an RFID tag that identifies the merchant terminal device 26 to enable linking of the customer's mobile communications device 28 to the merchant terminal device 26 via the host 22 for enabling transactions between the customer's mobile communications device 28 and that merchant terminal device 26. In such an example, the merchant terminal device 26 may be connected to the host system 22 via a first secure channel 25 and the customer's mobile communications device may be connected to the host 22 via a secure out of band channel 27, the connection between the merchant terminal device and the mobile communications device 28 being established by the mobile communications device application 305 providing the information read (using a camera 308 and/or RFID interface 320) from the visual code or RFID tag of the merchant terminal device 26 to the host system 22, and the host system 22 establishing the connection between the mobile communications device 28 and the merchant terminal system 26.

A further example of providing communication between the customer's mobile communications device 28 and the host system 22 via a secure out of band channel 27 can be effected by a merchant terminal system 26 reading a visual code and/or an RFID tag carried by the mobile communications device 28 and representing the unique mobile communications device identifier for the mobile communications device application instance. The visual code and/or RFID tag carried by the mobile communications device 28 can be read by a camera 208 and/or RFID interface 220 of the merchant terminal device 26. In such an example, a connection between the merchant terminal device 26 and the mobile communications device 28 can be established by the merchant terminal device 26 providing the information read from the visual code or RFID tag of the mobile communications device 28 via a secure channel 25 to the host system. The host system can then retrieve information identifying an out of band channel to the mobile communications device (for example a mobile telephony number of the mobile communications device) from information stored, for example, in the vault storage 12 or in storage in the host 22 in the merchant terminal device. The host can then use the retrieved information to establish a connection between the merchant terminal system 26 and the mobile communications device 28.

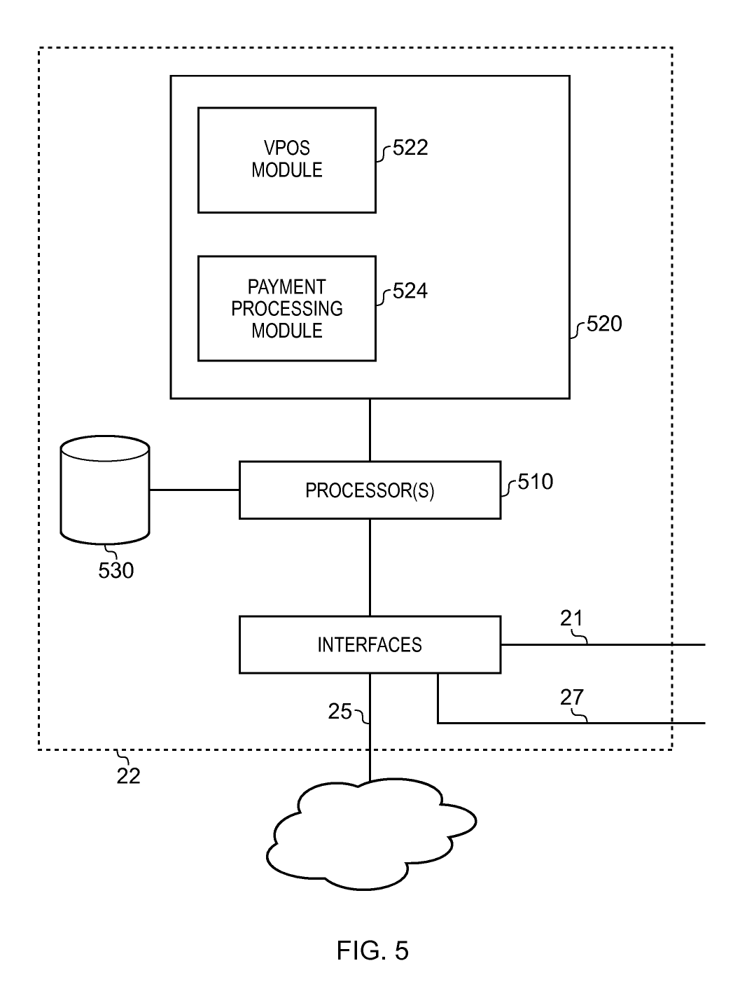

FIG. 5 is a schematic representation of a host system 22. The host system 22 can be configured as one or more conventional computer servers provided with one or more interfaces to enable the establishment of secure channels 25, 27 and 21 identified in FIG. 1. The host system 22 can include one or more processors 510, memory 520 containing data and software for programming the processors 520 to perform host system functions, and a data store 530 for providing persistent storage for programs and data for controlling the host system 22. The software held in the memory 520 and/or storage 530 can include a virtual point of sale (VPOS) module 522, for example implemented by one or more computer programs, for conducting point of sale operations for the merchant terminal devices, particularly in the example where the merchant terminal devices are simple terminals for the input and output of information and conventional point of sale processing functions are to be performed by the host system 22.

The VPOS module 522 can be configured to provide point of sale processing functions such as printing of receipts using a printer (not shown) at the merchant's premises, or by generating receipt files that can be downloaded to a merchant terminal 26 or a customer's mobile communications device 28. The VPOS module 522 can be operable to provide conventional point of sale functions such as authorisation and pre-authorisation of transactions, voiding of transactions, refund processes for transactions, tip management, profile management, voice referral and the generation of reports. In an example embodiment, the VPOS module 522 is operable to effect transaction processing, including authorisation, preauthorisation voiding and refund processes using a payment processing module 524.

The payment processing module 524, for example provided by one or more computer programs, provides functionality for performing transaction processing in response to operations performed using the mobile communications devices 28 and/or merchant terminal devices 26. The payment processing module 524 can be configured to provide functionality for effective customer credential verification, authorisation request handling, void request handling, refund request handling, voice referral request handling, pre-authorisation request handling, end of day closing and submission handling and report handling, for example for generating logs and journals and/or operational reports. Further details of aspects of payment processing are described later.

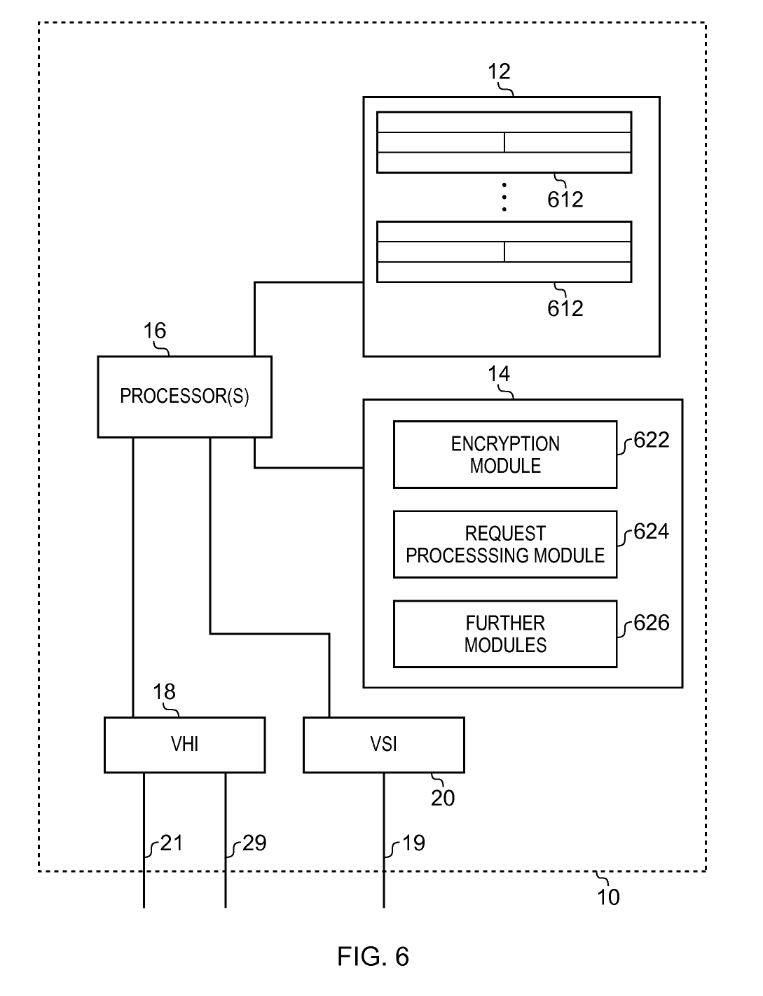

FIG. 6 is a schematic block diagram of a vault system (secure storage system) 10. The vault system 10 includes one or more processors 16, secure vault storage 12, which includes encrypted customer records 612, and storage/memory 14 used to store software and programs for controlling the processor(s) 16. Examples of the content of such customer records will be described in the following description. Processing modules held in the storage 14 can include an encryption module 622, for example implemented by one or more computer programs, for encrypting and decrypting data held in the vault storage 12, and a request processing module 624, for example implemented by one or more computer programs, for processing requests and responses in communication with the host system 22.

Further processing modules 626 can also be provided to implement functions such as, transaction management functions, report generation functions, merchant management functions, terminal fleet management functions and customer management functions. The transaction management functions can include, for example, credential verification functions, end of day clearing & submission functions, customer subscribing functions, customer modification and/or unsubscribing functions. The report generation functions can include the generation of logs & journals and the generation of operational reports. The merchant management functions can include merchant profile management and the generation of logs & Journals and/or operational reports. The terminal fleet management functions can similarly include terminal profile management functions, functions for controlling the installation of terminals, the upgrading of terminals and the uninstalling of terminals, and report generation functions for the generation of logs and journal and/or operational reports. The customer management functions can include customer profile management, the generation of the mobile communications device application IDs. Further details of aspects of some of these processes are described later.

As shown in FIG. 6, a vault-host interface 18 supports secure channels to the one or more hosts 22, and a vault system interface 20 supports one or more channels to an acquiring bank 30 and/or card scheme systems 32.

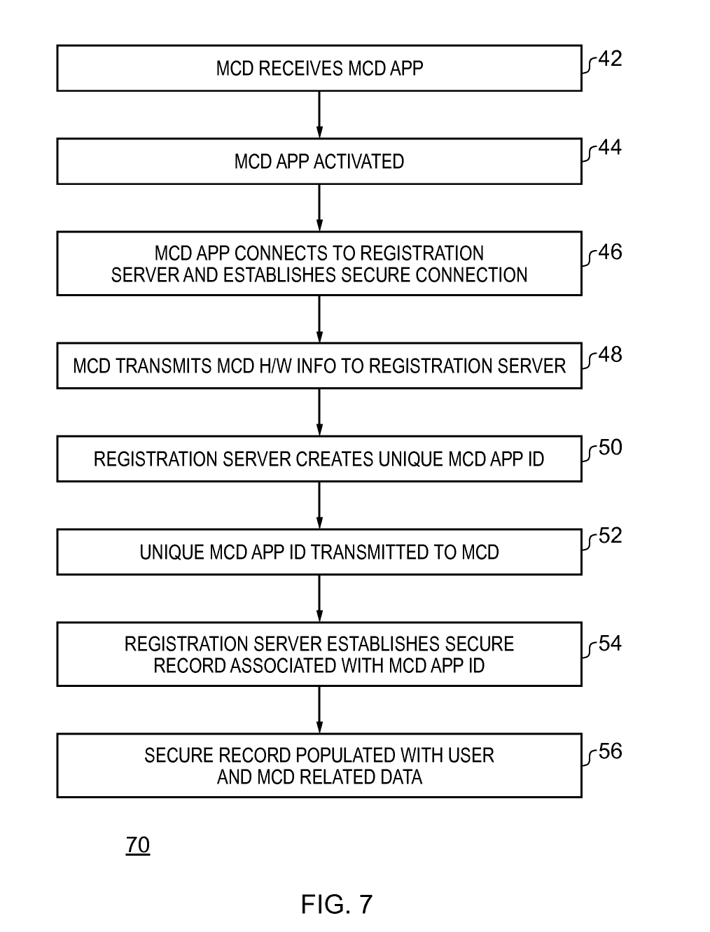

FIG. 7 illustrates an example registration process using a registration server 24 that is operable to communicate with the mobile communications devices 28 via secure channel 29 (either via a mobile telephony network or via, for example, the internet, or a combination of both).

As illustrated in FIG. 7, a registration process can be started by the customer requesting a mobile communications device application to be downloaded. The request for downloading the application can be via an application store of a mobile communications device provider, or from the registration server 24 directly. Accordingly, in step 42, the mobile communications device receives the requested mobile communications device application. The mobile communications device application provides a number of different services, including a user registration service that is configured to interact with the registration server 24 for user registration. The mobile communications device application is provided with, or includes a record of, a public key associated with a public-private key pair for registration, for which the private key is held by the registration server 24. The mobile communications device application can also be provided with, or include a record of a unique number representative of the instance of the application that is generated as part of the download process, for example, in the form of an application serial number that forms or is derived from a download sequence number. The registration public key and/or the application serial number can be held as metadata for the application in the mobile communications device storage.

In step 44, the mobile communications device application is activated on the mobile communications device 28.

In step 46, the mobile communications device application establishes a secure channel or link to the registration server 24 using a secure communications channel represented schematically as 29 in FIG. 1. As indicated above, this can be a secure channel provided via a mobile telephony network or via a wired connection over the internet. The channel can be made secure using for example, as secure socket layer (SSL) connection and/or through the use of the public-private key pair as discussed below.

In step 48, the mobile communications device application is operable to provide a data entry screen to the user to enable the user to enter an email address and registration verification information (i.e. verification information to be used for a registration process) in the form of one or more of a password, a passphrase, or another form of verification information (for example gestures to be entered at the mobile communications device). The mobile communications device application is then operable to retrieve from the mobile communications device hardware information identifying the mobile communications device hardware. The hardware identification information could, for example, be one or more of an International Mobile Equipment Identity (IMEI) of the mobile communications device, an Integrated Circuit Card ID (ICCID) of a Subscriber Identity Module (SIM) retrieved from the mobile communications device, or a Media Access Control (MAC) address for the mobile communication device. The mobile communications device application is then operable to encrypt the information entered by the user and hardware identification information using the public key and the resulting secure message is sent to the registration server. As part of the secured message, the mobile communications device application can also be operable to transmit to the registration server information identifying the particular instance (download) of the mobile communications device application. Alternatively, or in addition, the registration server can be operable to assign a unique identifier to the session initiated by the mobile communications device application to identify the mobile communications application.

In response to receipt of the secure message, the registration server can be operable to use the private key held by the registration server to decrypt the message and to extract the email address and registration verification information entered by the user and to transmit a link in the form, for example, of a uniform resource locator (URL), to the user in an email sent to the user at the email address provided by the user. The link identifies a secure registration website provided by the registration server 24 at which user account configuration information can be provided using an SSL or other secured connection. As an alternative, the registration server could send an email with two links, one to confirm the validity of the message received from the mobile device and a second link to reject the request.

In response to receipt by the user of the information defining the link, the user can use the link, either from the mobile communications device or from another device, to access the secure registration website provided by the registration server and to enter registration information. Before being able to enter registration information, the user is able to enter the email address and registration verification information provided in step 48 above via the mobile communications device application. Once the correct user name and registration verification information have been entered, the secure website then provides pages and fields in a conventional manner that can be used for the entry of information in connection with a user account identified by the email address. The registration information includes payment details for one or more payment accounts to be stored in the vault system 10 for association with the account identified by the email address. For example, the payment account details for a credit card can include the credit card number, the full name associates with the credit card, the expiry date, the card verification value (CVV). A nickname can be associated with each payment account as a shorthand for the user to identify an account and for speed of subsequent entry. Examples of different types of payment accounts include credit cards, debit cards, PayPal accounts, bank accounts, etc. Registration information can also include the personal information identifying the user (e.g., first, middle and family names, nationality, country of residence, etc.) and contact information for the user (home address(es), business address(es), additional emails address(es), landline and/or mobile telephone numbers etc.). The registration information can also include customer verification information such as a customer verification passphrase. The customer verification information can be same as the registration verification information. Alternatively, it can be required that customer verification information is different from the registration verification information to provide enhanced security.

Where the information is provided from the mobile communications device application, this can further by encrypted with the public key and then decrypted at the registration server using the public key. An electronic wallet at the mobile communications device can also be updated with the nicknames for the payment accounts.

In step 50, the registration server can perform a mathematical calculation to generate information identifying an instance of a mobile communications device application on a mobile communication device. The information identifying an instance of the mobile communications device application on the mobile communication device can be in the form of a unique mobile communications device application ID (MCDAPPID). The mathematical calculation can, for example, use the identifier for the mobile communications device hardware and an identification of the mobile communications device application instance (for example, by a fixed or random algebraic or algorithmic combination of the two identifiers) to generate the unique mobile communications device application ID (MCDAPPID). The identification of the mobile communications device application instance used in the calculation can, for example, be an application serial number generated, as described above, as part of the mobile communications device download process, (e.g. a download sequence number), or a unique number allocated to the user based on the time and/or place and/or sequence (with respect of other registration processes for other users) of the registration process for this user.

This unique MCDAPPID is then transmitted to the mobile communications device in step 52, either as a number that can then be used by the MCD application to generate a bar code, QR code or other visual code, or directly as the code. The code could also be used to program an RFID tag with the code for a mobile communications device 28 provided with an RFID tag 320 (see FIG. 3B). The unique MCDPPID can be sent as a secure email or as a packet of information to the mobile communication device and entry of the registration verification information can be required to open the MCDAPPID. The MCDAPPID is stored in the metadata for the mobile communications device application in the mobile communications device storage.

In step 54, the registration server establishes the secure connection to the vault system 10 and provides the vault processor with the entered information to establish a secure record for the customer using the MCDAPPID as part of the record and/or the customer account identifier. In order to provide for a secure connection, the registration server can be provided with a public key of a vault public-private key pair, wherein the private key is held by the vault system. The registration server can thus use the vault public key to encrypt the information to be transmitted to the vault system, which can then decrypt the information using its private key.

In step 56, a secure record is populated in the vault 12 with customer and MCD related data, for example provided and/or generated as part of the registration session between the user of the mobile communications device 28 and the registration server 24. The information can be provided by the customer as part of the initial registration process as described above, or can be effected as part of a separate session, for example, a separate session between a computer (not shown) of the customer and the registration server 24. The information held in a secure record for a customer can include mobile communications device information, including mobile communications device identification information identifying an instance of a mobile communications device application on a mobile communication device (e.g., an MCDAPPID). The mobile communications device information can also include mobile communications device access information, for example, a mobile phone number, an email address, social media identification information that can be used for communication with the mobile communications device, an application identifier for an application (e.g., the MCDAPP) on the mobile communications device, or other information for enable communication with the mobile communications device. The information held in a secure record for the customer can also include payment account information and customer verification information associated with the mobile communications device identification information.

Examples of information that can be provided by the customer (user) as part of the registration process and/or can be generated as part of the registration process, and can form part of the secure record 612 for the customer to be held in the vault storage 12 can include one or more of:

MCDAPPID;

a user title;

user name;

user email address;

user correspondence address;

mobile communications device contact number (e.g., a mobile telephone number);

other contact telephone number(s);

information for one or more payment accounts,

user verification passphrase and/or PIN;

other verification information;

user preferences;

user nationality;

passport or other identity document information;

Although, in the described embodiment, the mobile communications device information held in the secure customer record in the vault storage 12 includes mobile communications device access information, in other examples the mobile communications device access information could be held instead or in addition in a record associated with the mobile communications device identification information in one or more of the storage 14, in the host system 22, in a registration system 24, or elsewhere, subject to meeting appropriate security requirements.

The information for a payment accounts can identify, for example, a payment card account such as a credit card account, a debit card account, a bank account, etc., including information to enable authorisation and payment using the payment account, such as the expiry date, card security code (CSC), sometimes known as the card verification value (CVV) or card verification code (CVC), etc.

The customer preference information can include for example, the automatic identification of a preferred account for given circumstances where information for more that one payment account is provided. Preference information can also be set, for example, to enable payments to be made in the local currency of the merchant, a home currency of the card issuer for a given payment account, or another currency in given circumstances. Preference information can also be set that the customer wishes to take account of tax free purchase options when in countries for which tax free purchases are possible for the customer.

In one example a customer verification passphrase can include a string of alphanumeric characters of a length between a predetermined minimum and a predetermined maximum, (merely by way of example between 4 and 16 characters, say 12 characters). A default can be set that for any verification process where the customer is requested to verify authorised use of the mobile communications device to conduct a transaction, a randomly selected set of the of the characters of the passphrase need to be entered by the customer (say 4 of the 12 characters). It will be appreciated that the length of the passphrase and the number of characters that the customer is requested to input can be selected according to a particular desired level of security, and is not limited to the example of a 12 character passphrase and the random selection of four characters therefrom for customer verification purposes.

Optionally, the customer can select a desired degree of security by requiring one or both of the full customer verification passphrase and/or PIN or part of one or both for verification authorised use of the mobile communications device. Other possible verification information can also be stored, for example for a sequence of gestures to be entered on the mobile communications device, or for a challenge question and answer pair.

The information entered as part of the registration process is securely held on the vault storage 12, and is only accessible by the vault processor(s) 16 under the control of the vault processing logic held in storage 14.

The data held on the vault storage 12 is secured using appropriate encryption standards. In an example embodiment, data stored within the storage system is encrypted using the Advanced Encryption Standard (AES) specification and public/private keys pairs are periodically generated by external dedicated devices. In an example embodiment, the secure channels 21 and 19 are configured to use dedicated, private lines and are encrypted using Internet Protocol Security (IPSEC) related protocols. In an example embodiment, the secure channels 25, 27 and 29 use public lines and are encrypted using Secure Sockets layer (SSL) protocols. It will be appreciated that in other embodiments, different security standards can be employed, for example security standards that are subsequently developed and/or are required, for example, by regulatory bodies.

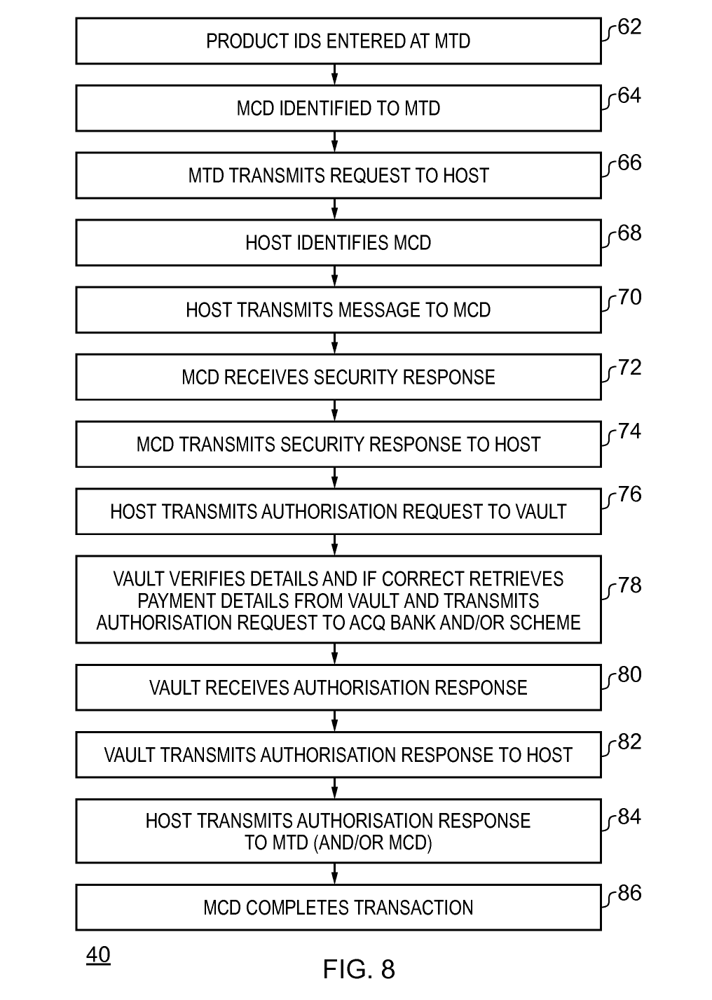

FIG. 8 is a flow diagram illustrating an example of a method of conducting a transaction using a system as described herein.

In step 62, a product identifier for a product that a customer wishes to purchase can be entered at the merchant terminal device 26 of a merchant. The product identifier could be entered by manually inputting information using a keyboard presented on the merchant terminal device, or by scanning an RFID tag provided on the product, or by scanning a product code represented as a barcode, QR code, or another form of visual code on the product.

At step 64, the mobile communications device 28 of the customer can be presented to the merchant terminal device. This can be achieved by manually entering on the merchant terminal device 28, a code displayed on the mobile communications device 28, or by scanning a barcode, QR code or other visual code displayed on the mobile communications device 28, by reading an RFID tag provided in or on the mobile communications device 28, or by an exchange of data via, for example, a network protocol or using SMS and/or emails. As explained above, the code that is provided by the mobile communications device is a unique code that can be generated from information identifying an instance of a transaction application held on the mobile communications device and information identifying the hardware of the mobile communications device. The unique code provides a unique identifier (unique mobile communications device identifier) for the mobile communications device that includes the instance of the mobile communications device.

In step 66, the merchant terminal device transmits a request to the host system 22 requesting verification information for the mobile communications device. The request transmitted to the host includes the unique mobile communications device identifier provided from the mobile communications device. The merchant terminal device can conduct this communication as an encrypted communication, for example using a public key of a host public-private key pair, wherein the private key is securely held by the host system 22. The host system 22 can then use the private key for the host public-private key pair to decrypt the content of the request.

In step 68, the host system 22 identifies the mobile communications device 28 using the unique mobile communications device identifier, and verifies that it is a mobile communications device which is registered for use with the transaction processing service. In an example embodiment, this verification includes the host 22 sending a message to the vault system 10, including the unique mobile communications device identifier, to request the vault system 10 to provide a request for verification information for the customer to verify that the mobile communications device is being used in an authorised manner. This request for verification information can be provided, for example, as part of a mobile communications device access information request for details of how to access a mobile communications device 28 for communicating with the customer. In an example embodiment the mobile communications device access information, that is information defining how to access can be provided to the mobile communications device can be held in the vault storage 12 of the vault system 10. Alternatively, or in addition, it could be held, for example, by the host system 22, or in another system such as the registration server 24. These communications can also be conducted using public-private key pair encryption.

As explained above, in an example embodiment the verification information that the customer is requested to input can be selected alphanumeric characters from an alphanumeric passphrase. In one example, the secure vault storage, as part of a customer record, can include a 12 character passphrase and the customer can be requested to input 4 of the 12 characters selected at random.

In this example, in response to a reply from the vault system 10, the host system 22 is operable in step 70 to communicate either with the mobile communications device directly via the out of band channels 27 or with the merchant terminal device 26 with a request for the customer to input the selected characters from the passphrase.

In step 72, the mobile communications device 28 of the customer or the merchant terminal device 26 of the merchant receives the response input by the customer.

In step 74, the customer response is transmitted by the mobile communications device or the merchant terminal device to the host system 22.

In step 76, the host then transmits an authorisation request to the vault system 10.

In step 78, the vault processing logic 16 of the vault system 10 receives the authorisation request, containing the unique mobile communications device identifier, the customer verification information and the transaction amount information. The vault processing logic is operable to retrieve from the vault storage 12 the customer account information, based on the unique mobile communications device identifier and is operable to confirm that the verification information entered by the customer is correct. In the event that the unique mobile communications device identifier and the verification information correspond to information securely stored in the vault storage 12, the vault processing logic is operable to retrieve from the secure storage 12 information identifying a customer account previously registered by the customer with the vault system 10. As discussed above, the customer account can be in the form of a payment account (typically termed a payment card account, such as a credit card account, a debit card account, etc).

In step 78, the vault processing logic is further operable to transmit an authorisation request via the vault system interface 20 to an acquiring bank system 30 and/or a card scheme system 32 requesting authorisation for the requested transaction amount using the requested payment account.

In step 80, it is assumed that the vault processing logic 16 receives a positive authorisation response from the acquiring bank system 30 and/or the card scheme system 32.

In step 82, the vault transmits an authorisation response message to the host 22 confirming authorisation for payment. However, the authorisation message sent to the host 22 does not need to identify the payment account from which the payment is to be made, but instead indicates that the payment is authorised by the vault system 10.

In step 84, the host transmits an authorisation request to the merchant terminal device 26 (and/or to the mobile communications device 28). The message transmitted to the merchant terminal device 26 does not indicate the payment account from which the payment is to be made, but merely indicates that the system 24 authorises the transaction to be performed and confirms that payment will be made.

In step 86, the transaction can be completed by the merchant terminal device and/or mobile communications device by closing the transaction.

As discussed above, information is registered with the vault system 10 and, as part of a registration process, a unique mobile communications device identifier can be generated for the instance of the transaction application on the mobile communications device 28.

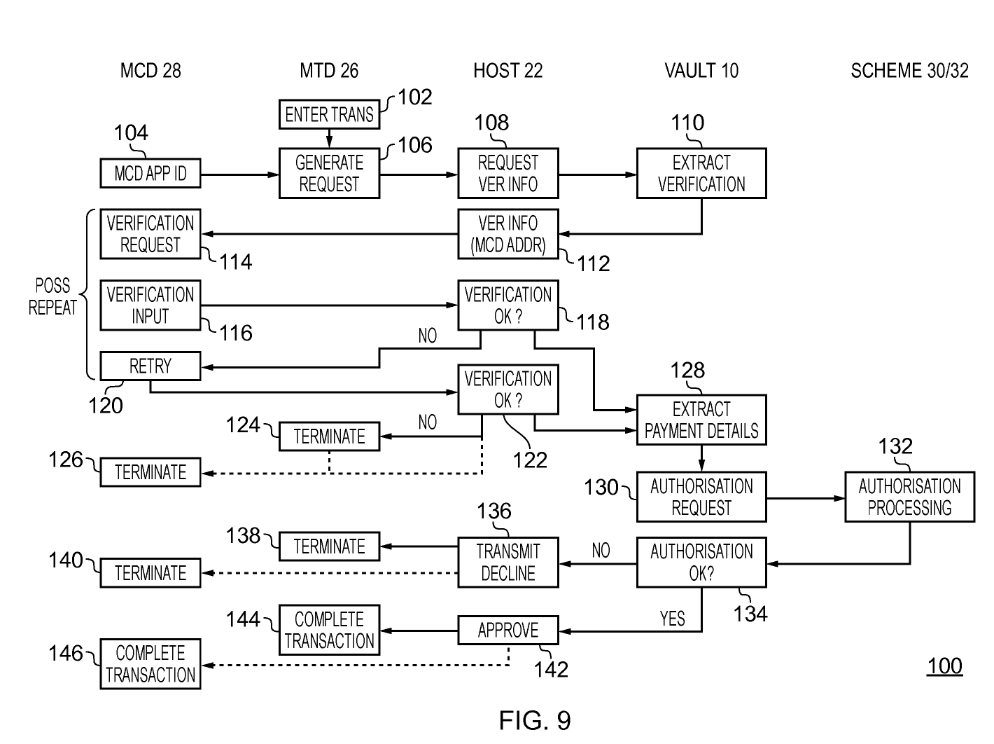

FIG. 9 is a schematic diagram illustrating an example of a transaction process showing steps performed by the various logical entities shown in FIG. 1.

In this example, in step 102, a transaction is initiated at an MTD 26 including, for example, the input of one or more product IDs to form the basis of a transaction. In step 104, the MCDAPPID is provided by the MCD 28 to the MTD 26.

In step 106, a request is generated for verification information for the MCDAPPID and is transmitted the host 22.

At step 108, the host 22 transmits a request for the verification information to the vault 10. At step 110, the vault 10 extracts the verification information for the MCDAPPID. As indicated above, the verification information may include a selection of a number of characters from a passphrase, the characters being selected at random from the passphrase. However, in a variation with respect to the example described with reference to FIG. 8, in this example the vault 10 is operable to return the verification information to the host 22 in a message that specified the information to be requested from the customer and also the expected response.

In step 112, the host 22 provides the verification information to the MCD 28 (or alternatively—not shown) to the MTD 26.

In step 114, the verification request is displayed on the MCD 28.

The customer is prompted to input the required verification information at step 116 and the verification information is then transmitted to the host 22.

In this example it is the host 22 that verifies, in step 118, whether the response provided by the customer is the expected response (rather than this being performed by the vault system 10).

If the verification information provided by the customer does not match the expected verification information provided by the vault system 10 to the host 22, then optionally at step 120, the customer can be given the operation to retry entry of the verification information at step 120.

In this case, then at step 122, the verification information is once again checked at the host 122.

If the verification information is not correct at step 122, then the transaction can be terminated and a message can be sent to the MTD 26 at step 124 and/or to the MCD 28 at step 126 to this effect.

Although in FIG. 4 only one retry at step 120 is illustrated, in alternative embodiments more or less options to retry the input of the verification information can be provided to the customer. Rather than the verification information being requested on the MCD 28, in an alternative embodiment the entry of the MCD information can be effected on the MTD 26 by the customer.

If at step 118 or 122 the verification information is determined to be correct, then an authorisation request message is sent by the host 22 to the vault system 10 to request authorisation for a transaction for the customer. The authorisation request message includes the MCDAPPID, the transaction amount and the customer verification response.

At step 128 the vault system 10 is operable to use the MCDAPPID to retrieve payment account information associated with the MCDAPPID from the vault storage 22.

At step 130, the vault system 10 generates an authorisation request including the payment account information required to request authorisation along with the transaction amount to be authorised in a currency the customer has specified. This authorisation request is then sent to the card scheme system 32, either directly or via the acquiring bank system 30. The card scheme system 32, after communicating with the issuing bank 34 for the payment account, can return an authorisation message to the vault system 10.

If, at step 134, the authorisation response received indicates that the authorisation is declined, then the vault transmits a decline message to the host 22.

In this case the host 22 is then operable at step 136 to transmit information indicating that the payment is declined to the MTD 26 and/or the MCD 28 to terminate the transaction at steps 138/140.

Alternatively, if the authorisation response received by the vault system 10 indicates that the authorisation is approved, then at step 134 the vault 10 transmits the approve message to the host 22.

In this case the host 22 is then operable at step 142 to transmit a message to the MTD 26 and/or the MCD 28 to complete the transaction at steps 144/146.

In the process steps described above, various messages are passed between the respective components of the system illustrated in FIG. 1. In order to link the messages relating to a given transaction, each of those messages is provided with a transaction identifier, whereby request and response messages for a transaction, or session, can be linked.

In the example of FIG. 9, it is to be understood that the communications can be effected using public-private key encryption as discussed above.

An example embodiment can provide simplicity and flexibility of use as perceived by both customers and merchants, while also providing security and integrity of operation. In an example embodiment transactions between customer and merchants can be supported without a customer needing to present a payment card to a merchant, enhancing security of operation and reducing the possibilities of fraud.

It should be noted that the terms “customer” and “user” are used interchangeably herein. In the example embodiments described above, transactions are described as being between a customer (user) and a merchant. However, it should be noted that in other examples the relationship of customer and merchant could be more generally between a purchaser and a vendor, wherein the transactions are peer to peer. For example the transactions could be between two private individuals where a “merchant terminal device 26” is a mobile communications device of a vendor and the “merchant system 400” is a hosted system for supporting sales using the vendor's mobile communication device. In such an example, the “customer” is the purchaser and the “customer's (user's) mobile communication device” is the purchaser's mobile communications device. In other examples, the system as described could be used for business to business transactions.

Although the embodiments described above have been described in detail, numerous variations and modifications will become apparent to those skilled in the art once the above disclosure is fully appreciated. It is intended that the following claims be interpreted to include all such variations and modifications and their equivalents.

1. A storage system comprising:
storage securely storing user information including, for a user, mobile communications device information, including mobile communications device identification information that identifies an instance of a mobile communications device application on a mobile communications device, payment account information and user verification information associated with the mobile communications device identification information; and
storage system processing means configured
to receive from a transaction system a first transaction authorisation request message including transaction amount information, mobile communications device identification information and user verification information; and
to determine whether the received user verification information corresponds to stored user verification information for the mobile communications device identified in the transaction authorisation request and, where the received user verification information corresponds to the stored user verification information,
to retrieve from the storage the payment account information associated with the mobile communications device identification information,
to transmit to an authorisation system a second authorisation request message that includes the transaction amount information and the payment account information, and
on receipt from the authorization system of a first authorization response message in response to the second authorization message to cause a second authorization response message to be transmitted to the transaction system without identifying the payment account information.

2. The storage system of claim 1, wherein the mobile communications device information held in the storage includes mobile communications device access information associated with the mobile communications device identification information and the storage system processing means is configured, in response to receipt from the transaction system of a mobile communications device access information request including the mobile communications device identification information,
to retrieve from the storage mobile communications device access information associated with the mobile communications device identification information,
to transmit to the transaction system a mobile communications device access information response that includes the mobile communications device access information associated with the mobile communications device identification information.

3. The storage system of claim 2, wherein the storage system processing means is further configured, in response to receipt from the transaction system of a mobile communications device access information request including the mobile communications device identification information,
to retrieve from the storage the user verification information associated with the mobile communications device identification information,
to determine a subset of the user verification information,
to transmit to the transaction system a mobile communications device access information response that further includes a request for the determined subset of the user verification information.

4. The storage system of claim 3, wherein confirming whether the received user verification information corresponds to stored user verification information for the mobile communications device identified in the transaction authorization request comprises confirming that the received user verification information corresponds to the determined subset of the user verification information.

5. The storage system of claim 1, wherein the storage securely stores at least one of:
encrypted payment account information;
currency choice preference information; or
tax free purchase preference information.

6. A system comprising the storage system of claim 1 and the transaction system, wherein the transaction system comprises transaction system processing means configured on receipt from a merchant system of an initial transaction authorisation request message including transaction amount information and mobile communications device identification information,
to obtain mobile communications device access information associated with the mobile communications device identification information,
to transmit to the mobile communications device a transaction verification request message including transaction amount information and a request for user verification information, and
in response to receipt, from the mobile communications device of a transaction verification response message user verification information,
to transmit to the storage system the first transaction authorization request message including the transaction amount information, the mobile communications device identification information and the user verification information.

7. A system comprising a transaction system, the transaction system comprising transaction system processing means configured on receipt from a merchant system of an initial transaction authorisation request message including transaction amount information and mobile communications device identification information,
to obtain mobile communications device access information associated with the mobile communications device identification information,
to transmit to the mobile communications device a transaction verification request message including transaction amount information and a request for user verification information, and
in response to receipt from the mobile communications device of a transaction verification response message user verification information,
to transmit to a storage system the first transaction authorization request message including the transaction amount information, the mobile communications device identification information and the user verification information.

8. The system of claim 7, wherein the transaction system processing means is configured
in response to receipt from the merchant system of the initial transaction authorisation request message including the transaction amount information and the mobile communications device identification information,
to transmit to the storage system a mobile communications device access information request including the mobile communications device identification information, and
in response to a mobile communications device access information response from the storage system that includes the mobile communications device access information associated with the mobile communications device identification information, to transmit to the mobile communications device the transaction verification request message including transaction amount information and a request for user verification information.

9. The system of claim 7, further comprising the merchant system, wherein the merchant system comprises
means for inputting product identification information for a purchase transaction,
means for inputting mobile device identification information identifying a user's mobile communications device for the purchase transaction,
merchant system processing means operable to transmit, to the transaction system, the initial transaction authorisation request message including the transaction amount information and mobile communications device identification information, and
on receipt from the transaction system of the second authorization response message to issue a receipt for completing the purchase transaction for the user.

10. The system of claim 9, wherein the means for inputting the mobile device identification information comprises an RFID reader for reading an RFID identifier that is associated with the mobile communications device and represents the mobile communications device identifier.

11. The system of claim 10, wherein the RFID reader is an NFC reader.

12. The system of claim 9, wherein the means for inputting the mobile device identification information comprises an imaging device for imaging a visual code that is displayed by the mobile communications device and represents the mobile communications device identifier.

13. The system of claim 7, wherein the mobile communications device identifier is generated from an algebraic or algorithmic combination of an identifier for the mobile communications device hardware and an identifier for an instance of the mobile communications device application on the mobile communications device.

14. The system of claim 13, wherein the unique mobile communications device identifier is generated by a registration server as part of a registration process for registering the mobile communications device and the instance of the application.

15. A registration server configured
to communicate with an application on a mobile communications device to identify an identifier for the mobile communications device hardware and an instance of the application,
to generate a unique mobile communications device identifier for the instance of the application on that mobile communications from the identifiers for the instance of the application and for the mobile communications device hardware, and
to transmit the unique mobile communications device identifier for storage by the application on the mobile communications device.

16. A method comprising
securely storing, on a storage of a storage system, user information including, for a user, mobile communications device information including mobile communications device identification information that identifies an instance of a mobile communications device application on a mobile communications device, payment account information and user verification information associated with the mobile communications device identification information, and
receiving at the storage system from a transaction system a first transaction authorisation request message including transaction amount information, mobile communications device identification information and user verification information; and
determining by the storage system whether the received user verification information corresponds to stored user verification information for the mobile communications device identified in the transaction authorisation request and, where the received user verification information corresponds to the stored user verification information,
retrieving by the storage system from the storage payment account information associated with the mobile communications device identification information,
transmitting by the storage system to an authorisation system a second authorisation request message that includes the transaction amount information and the payment account information, and
on receipt by the storage system from the authorization system of a first authorization response message in response to the second authorization message, causing a second authorization response message to be transmitted to the transaction system without identifying the payment account information.

17. The method of claim 16, the mobile communications device information held in the storage includes mobile communications device access information associated with the mobile communications device identification information, the method comprising, in response to receipt from the transaction system of a mobile communications device access information request including the mobile communications device identification information,
retrieving by the storage system from the storage mobile communications device access information associated with the mobile communications device identification information,
transmitting by the storage system to the transaction system a mobile communications device access information response that includes the mobile communications device access information associated with the mobile communications device identification information.

18. The method of claim 17, further comprising, in response to receipt from the transaction system of a mobile communications device access information request including the mobile communications device identification information,
retrieving by the storage system the user verification information associated with the mobile communications device identification information,
determining by the storage system a subset of the user verification information,
transmitting by the storage system to the transaction system a mobile communications device access information response that further includes a request for the determined subset of the user verification information.

19. The method of claim 18, wherein confirming that the received user verification information corresponds to the determined subset of the user verification information.

20. The method of claim 16, comprising securely storing in the storage at least one of:
encrypted payment account information in the storage;
currency choice preference information; or
tax free purchase preference information.

21. The method of claim 16, comprising, on receipt from a merchant system by the transaction system of an initial transaction authorisation request message including transaction amount information and mobile communications device identification information,
obtaining by the transaction system mobile communications device access information associated with the mobile communications device identification information,
transmitting by the transaction system to the mobile communications device a transaction verification request message including transaction amount information and a request for user verification information, and
in response to receipt from the mobile communications device of a transaction verification response message user verification information, transmitting by the transaction system to the storage system the first transaction authorisation request message including the transaction amount information, the mobile communications device identification information and the user verification information.

22. The method of claim 21, comprising, on receipt by the transaction system from the merchant system of the initial transaction authorisation request message including the transaction amount information and mobile communications device identification information,
transmitting by the transaction system to the storage system a mobile communications device access information request including the mobile communications device identification information, and
in response to a mobile communications device access information response from the storage system that includes the mobile communications device access information associated with the mobile communications device identification information, transmitting by the transaction system to the mobile communications device the transaction verification request message including transaction amount information and a request for user verification information.

23. The method of claim 16, further comprising
receiving by a merchant system product identification information for a purchase transaction;
receiving by the merchant system mobile device identification information identifying a user's mobile communications device for the purchase transaction;
transmitting by the merchant system to the transaction system the initial transaction authorisation request message including the transaction amount information and mobile communications device identification information, and
on receipt by the merchant system from the transaction system of the second authorisation response message, issuing a receipt for completing the purchase transaction for the user.

24. The method of claim 23, comprising receiving input of the mobile device identification information by reading an RFID identifier that is associated with the mobile communications device and represents the mobile communications device identifier.

25. The method of claim 23, comprising receiving input of the mobile device identification information by imaging a visual code that is displayed by the mobile communications device and represents the mobile communications device identifier.

26. The method of claim 16, wherein the mobile communications device identifier is generated from an algebraic or algorithmic combination of an identifier for the mobile communications device hardware and an identifier for an instance of the mobile communications device application on the mobile communications device.

27. The method of claim 26, comprising generating, by a registration server, the unique mobile communications device identifier as part of a registration process for registering the mobile communications device and the instance of the application.

28. A method comprising steps performed by a registration server of
communicating with an application on a mobile communications device to identify an identifier for the mobile communications device hardware and an identifier for an instance of the application on the mobile communications device;
generating a unique mobile communications device identifier for the instance of the application on that mobile communications device from the identifiers for the instance of the application and for the mobile communications device hardware;
transmitting the unique mobile communications device identifier for storage by the application on the mobile communications device.

29. The method of claim 28, wherein the mobile communications device identifier is generated from an algebraic or algorithmic combination of an identifier for the mobile communications device hardware and an identifier for an instance of the mobile communications device application on the mobile communications device
